(19) United States
(12) Patent Application Publication
(10) Pub. No.: US 2024/0251468 A1
(43) Pub. Date: Jul. 25, 2024

(54) BEAM INDICATION METHOD AND APPARATUS

(71) Applicant: ZTE Corporation, Shenzhen (CN)

(72) Inventors: Ling YANG, Shenzhen (CN); Bo GAO, Shenzhen (CN); Zhaohua LU, Shenzhen (CN); Xiaolong GUO, Shenzhen (CN); Ke YAO, Shenzhen (CN); Shujuan ZHANG, Shenzhen (CN)

(21) Appl. No.: 18/397,211

(22) Filed: Dec. 27, 2023

Related U.S. Application Data
(63) Continuation of application No. PCT/CN2023/072722, filed on Jan. 17, 2023.

(51) Int. Cl. H04W 76/20; H04B 7/06; H04W 36/08; H04W 80/02

(52) U.S. Cl. CPC H04W 76/20; H04B 7/0626; H04W 36/08; H04W 80/02

(57) ABSTRACT

A method of wireless communication includes transmitting, by a network device, a message that includes a cell switch command and N transmission configuration indicator (TCI) states for one or more candidate cells or a target cell, where N is a positive integer. Another method of wireless communication includes transmitting, by a network device, a message indicating N transmission configuration indicator (TCI) states for one or more candidate cells or a target cell, where N is a positive integer such that the message excludes a cell switch command.

### CROSS REFERENCE TO RELATED APPLICATIONS

This patent document is a continuation of and claims benefit of priority to International Patent Application No. PCT/CN2023/072722, filed on Jan. 17, 2023. The entire content of the before-mentioned patent application is incorporated by reference as part of the disclosure of this application.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity as well as wireless device location information. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society which includes location information.

### SUMMARY

Various techniques are described for indication of beam states in a wireless network.

In one aspect, a method of wireless communication is disclosed. The method includes transmitting, by a network device, a message that includes a cell switch information and N transmission configuration indicator (TCI) states for one or more candidate cells or a target cell, where N is a positive integer.

In another example aspect, another method of wireless communication is disclosed. The method includes transmitting, by a network device, a message indicating N transmission configuration indicator (TCI) states for one or more candidate cells or a target cell, where N is a positive integer such that the message excludes a cell switch information.

In another example aspect, another method of wireless communication is disclosed. The method includes receiving, by a wireless device from a network device, a message that includes a cell switch information and N transmission configuration indicator (TCI) states for one or more candidate cells or a target cell, where N is a positive integer; and operating the wireless device according to the message.

In another example aspect, another method of wireless communication is disclosed. The method includes operating a wireless communication device to transmit or receive a reference signal (RS) or channel or signal in a network, wherein the reference signal (RS) is assumed to be quasi-colocated (QCLed) with another RS.

In another example aspect, another method of wireless communication is disclosed. The method includes receiving, by a wireless device from a network device, a message indicating N transmission configuration indicator (TCI) states for one or more candidate cells or a target cell, where N is a positive integer such that the message excludes a cell switch information; and operating the wireless device according to the message.

In another aspect, an apparatus is disclosed. The apparatus includes a processor configured to implement the above-described method.

In yet another aspect, a computer readable medium is disclosed. The computer readable medium stores code, which, upon execution by a processor, causes the processor to implement a method described herein.

These, and other, aspects are described throughout the present document.

### BRIEF DESCRIPTION OF THE DRAWINGS

FIGS. 1 to 12 depict various configurations of TCI states, TCI state pools.

FIGS. 13 to 17 depict flowcharts for various examples of wireless communication methods.

FIG. 18 shows an example of a block diagram of a wireless communication system.

FIG. 19 shows an example of a block diagram of a wireless communication device or a network node.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

When the UE moves from the coverage area of one cell to another cell, at some point a serving cell change needs to be performed. Currently, serving cell change is triggered by layer 2 (L3) measurements and is done by radio resource control (RRC) signaling triggered Reconfiguration with Synchronisation for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, in order to reduce the latency, overhead and interruption time.

This document provides, among other solutions, a method of beam indication for L1/L2 mobility enhancements.

In RAN Plenary #94 e-meeting, a new work item (WI) on further new radio (NR) mobility enhancements was approved. The goal of this item is to enable a serving cell change via L1/L2 signaling with low latency, overhead and interruption time. In order to support cell change, some enhancement on TCI state indication need to be considered, such as the TCI state indication and application time for the case of TCI state indication for candidate cell(s) or target cell together with cell switch command, related quasi-co-location (QCL) assumption and so on.

The present document provides, among other things, some feasible solutions to the issue mentioned above.

In the document, quasi co-located, QCL can be defined as: two antenna ports are said to be quasi co-located if the large-scale properties of the channel over which a symbol on one antenna port is conveyed can be inferred from the channel over which a symbol on the other antenna port is conveyed. In the existing specification, QCL type includes one of “QCL-TypeA”, “QCL-TypeB”, “QCL-TypeC”, “QCL-TypeD”, wherein ‘typeA’: {Doppler shift, Doppler spread, average delay, delay spread}; ‘typeB’: {Doppler shift, Doppler spread}; ‘typeC’: {Doppler shift, average delay}; ‘typeD’: {Spatial Rx parameter}.

Currently, in the fifth generation (5G) protocol, a transmission control indicator (TCI) state is used to provide or indicate some information helpful for transmission or reception of signals. For example, QCL source reference signal, QCL type, cell information, path loss information, etc. may be included in a TCI state. Typically, TCI state only indicates a large-scale property that can be obtained from one or more reference signals. The reference signal can be seen as source reference signal. Further, target reference signal or channel can be configured or indicated the available TCI state(s).

In the present document, the term cell switch information or cell switch command may include at least one of target cell (or cell group) identification, a target candidate cell (or cell group) identification, Timing Advance (TA), synchronization signal/physical broadcast channel SS/PBCH block configuration or index, received signal strength indicator (RSSI) Measurement Timing Configuration (RMTC), channel state information (CSI) reference signal (RS) CSI-RS configuration, CSI-RS resource set index, sounding reference signal SRS resource index, SRS resource set index, CSI-RS resource index, CSI report configuration index, the gap of consecutive CSI-RS transmission occasion, the number of transmitting CSI-RS occasion, TCI state index, beam indication, a set of TCI state, preamble index, frequency information, Bandwidth part (BWP) index, measurement gap, the times of cell switch command or information to be allowed to be transmitted, ControlResourceSet (CORESET) information, search space information, activated or updated one or multiple TCI states, enable or maintain activated or updated one or multiple TCI states.

Some example embodiments that provide various solutions to the above-discussed problems, and others, are described below.

### Embodiment 1

In the embodiment, we mainly introduce the signaling framework to indicate TCI state.

In some examples, TCI state(s) for candidate cell(s) or target cell(s) can be indicated to be independent of cell switch command or together with cell switch command.

For the case that TCI state indication for candidate cell(s) or target cell together with cell switch command, at least one of the following methods to indicate TCI state can be used:
Method-1:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE (medium access control control element) for cell switch command indicates or updates one or two or multiple TCI state for candidate cell(s) or target cell(s).
More details on TCI state indication for at least one of serving cell, candidate cell(s) or target cell can be found in the embodiment 4.
Method-2:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE activates or deactivates at least one of TCI state(s) and TCI state pool;
More details on activation or deactivation can be found in the embodiment 3.
   Step-3: MAC CE for cell switch command indicates or updates one or two or multiple TCI state for candidate cell(s) or target cell(s) from the activated or deactivated at least one of TCI state(s) and TCI state pool.
More details on TCI state indication for at least one of serving cell, candidate cell(s) or target cell can be found in the embodiment 4.
Method-3:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE activates or deactivates at least one of TCI state(s) and TCI state pool;
More details on activation or deactivation can be found in the embodiment 3.
   Step-3: DCI indicates or selects one or multiple TCI states for candidate cell(s) or target cell.
In some examples, if target cell is unknown before DCI to indicate one or multiple TCI states for candidate cells or target cell, DCI can indicate one or multiple TCI states for each candidate cell.
In some examples, if target cell is known before DCI to indicate one or multiple TCI states for candidate cells or target cell, DCI only indicates one or multiple TCI states for target cell.
More details on TCI state indication for at least one of serving cell, candidate cell(s) or target cell can be found in the embodiment 4.
   Step-4: MAC CE for cell switch command indicates or updates one or two or multiple TCI state for candidate cell(s) or target cell(s) from the indicated or selected TCI state(s).
More details on TCI state indication for at least one of serving cell, candidate cell(s) or target cell can be found in the embodiment 4.
In some examples, MAC CE to trigger cell switch can indicate the same TCI state(s) or another TCI state(s) to UE with the indicated TCI state(s) by DCI.
In some example, MAC CE to trigger cell switch does not indicate TCI state to UE again after DCI indicates one or multiple TCI states for target cell.
Method-4: The beam information can be determined by QCL assumption between source RS and target RS.
   More details on QCL assumption or relationship between RSs can be found in the embodiment 6.

For the case that TCI state indication for candidate cell(s) or target cell to be independent of cell switch command, at least one of the following methods to indicate TCI state can be considered:
Method-1: similar signaling framework to indicate TCI state as Rel-17 ICBM, e.g., RRC+MAC CE, RRC+MAC CE+DCI.
   For example, RRC configuration TCI state pool or TCI state set for serving cell and/or candidate cell; MAC CE activates or deactivates one or L TCI states for serving cell and/or candidate cell; if the number of activated or deactivated TCI states is larger than or equal to a threshold, DCI indicates one or K TCI states for candidate cell(s) or target cell. Wherein, K is less than or equal to L.
Method-2:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE directly activates or deactivates or update one or multiple TCI states for candidate cell or target cell, and/or indicates or updates one TCI state to UE to receive or transmit DL or UL channel/signal from target cell or candidate cell.
In some examples, related details on activation or deactivation of TCI state or TCI state pool can be found in the embodiment 3.
More details on TCI state indication for at least one of serving cell, candidate cell(s) or target cell can be found in the embodiment 4.
Method-3:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE directly activates or deactivates or update one or multiple TCI states for candidate cell or target cell.
In some examples, related details on activation or deactivation of TCI state or TCI state pool can be found in the embodiment 3.
   Step-3: DCI indicates one or multiple TCI states to UE to receive or transmit DL or UL channel/signal from candidate cell or target cell. Optionally, maintain a set of activated TCI state of target cell or candidate cell(s).
More details on TCI state indication for at least one of serving cell, candidate cell(s) or target cell can be found in the embodiment 4.
Method-4:
   Step-1: RRC configure TCI state pool(s) or TCI state(s) or TCI state set;
More details on TCI state pool(s) for at least one of serving cell, candidate cell(s) or target cell can be found in the embodiment 2.
   Step-2: MAC CE activates or deactivates or update one or multiple TCI states for candidate cell or target cell.
In some examples, related details on activation or deactivation of TCI state or TCI state pool can be found in the embodiment 3.
   Step-3: MAC CE indicates one or multiple TCI states to UE to receive or transmit DL or UL channel/signal from candidate cell or target cell. Optionally, maintain a set of activated TCI state of target cell or candidate cell(s).
More details on TCI state indication for at least one of serving cell, candidate cell(s) or target cell can be found in the embodiment 4.

### Embodiment 2: (Relationship Between TCI State POOL and Cell, and Configuration Method)

In the embodiment, the relationship between TCI state(s) and cell, and how to configure TCI state(s) for cell or how UE obtain TCI state(s) is disclosed. In some embodiments, a cell corresponds to at least one of serving cell, candidate cell(s) and target cell.

Regarding relationship between TCI state(s) and cell, one of the following methods can be used:

### Method-1: Joint TCI State Pool can be Used or Configured for Cell.

The term “joint TCI state pool” can be replaced with one of common TCI state pool, or common TCI state set, or common TCI state list, joint TCI state set, joint TCI state list or other similar term.

In some embodiments, a joint TCI state pool includes one or more TCI states. In some examples, the number of TCI state in joint TCI state pool is assumed as M. M is an integer larger than or equal to 1. The (maximum) number of TCI state in TCI state pool can be a configurable value or fixed value or depends on UE capability.

In some examples, candidate cell is a potential target cell to switch. The number of candidate cell is assumed as N. Optionally, the number of candidate cell is an integer larger than or equal to 0 or 1. The (maximum) number of candidate cell can be configurable or fixed value or depends on UE capability or measurement result.

In some examples, joint TCI state pool includes M TCI states, which can be used for serving cell and/or candidate cell(s). Wherein, X1 TCI states can be used for candidate cell #1, X2 TCI states can be used for candidate cell #2, . . . , Xn TCI states can be used for candidate cell #N. Y TCI states can be used for serving cell. Optionally, the sum of X1, X2, . . . , Xn and Y can be less than or equal to M. Optionally, the number of TCI state for each cell can be same or different or fixed or configurable or changeable. Optionally, the relationship or mapping between TCI state and cell can be defined or introduced or updated or left it to the implementation. Such relationship or mapping can be determined or updated or changed by at least one of default method, RRC signaling, pre-defined method, MAC CE signaling and DCI signaling.

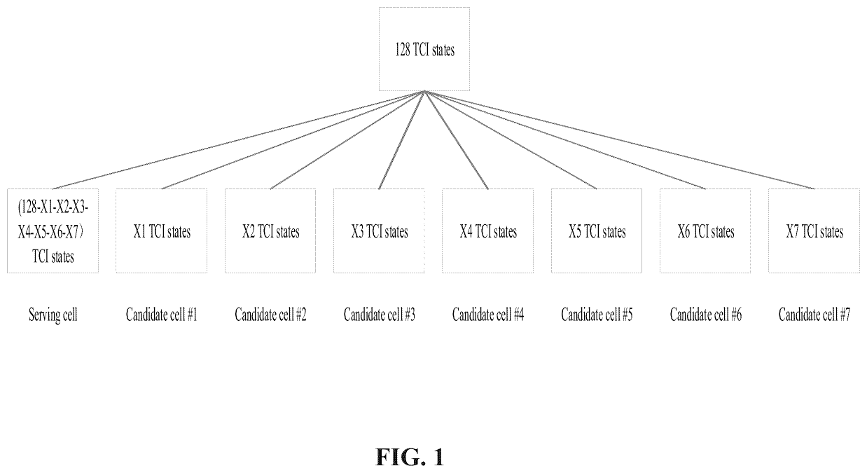

In FIG. 1, it is assumed that 128 TCI states (corresponding to TCI state pool) is used for serving cell and candidate cell(s). The number of candidate cell is 7. The number of TCI state is marked as X1, X2, X3, X4, X5, X6, X7 in turn corresponding to candidate cell #1, #2, #3, #4, #5, #6, #7. For serving cell, the number of TCI state is 128-X1-X2-X3-X4-X5-X6-X7.

### Method-2: Separate TCI State Pool can be Used or Configured for Serving Cell and Candidate Cell(s). Wherein, Candidate Cell(s) Share a Common TCI State Pool.

To be specific, a TCI state pool (e.g., the first TCI state pool) is used for serving cell. The other TCI state pool (e.g., the second TCI state pool) is used for candidate cell(s), which is shared or common used for all candidate cell.

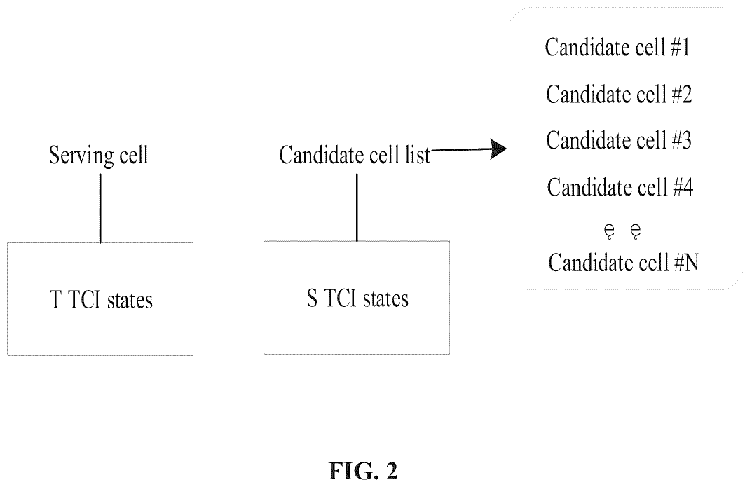

In some examples, the number of TCI state for the first TCI state pool is assumed as T. The number of TCI state for the second TCI state pool is assumed as S, as shown in FIG. 2. T or S is an integer larger than or equal to 1. The (maximum) value of T or S can be a configurable value or fixed value or depends on UE capability. Optionally, the number of TCI state for the first TCI state pool and the second TCI state pool can be same or different.

In some examples, a candidate cell is a potential target cell to switch a UE's coverage. The number of candidate cell is assumed as N (a positive integer). Optionally, the number of candidate cell is an integer larger than or equal to 0 or 1. The (maximum) number of candidate cell can be configurable or fixed value or depends on UE capability or measurement result.

In some examples, the second TCI state pool includes S TCI states, which can be used for candidate cell(s). Wherein, X1 TCI states can be used for candidate cell #1, X2 TCI states can be used for candidate cell #2, . . . , Xn TCI states can be used for candidate cell #N. Optionally, the sum of X1, X2, . . . , Xn−1 and Xn can be less than or equal to S. Optionally, the relationship or mapping between TCI state in the second TCI state pool and candidate cell can be defined or introduced or updated or left it to the implementation. Such relationship or mapping can be determined or updated or changed by at least one of default method, RRC signaling, pre-defined method, MAC CE signaling and DCI signaling.

### Method-3: Separate TCI State Pool can be Used or Configured for Serving Cell and Candidate Cell(s). Wherein, Each Candidate Cell has its Own TCI State Pool.

Here, the number of candidate cell is assumed as N. Wherein, candidate cell is a potential target cell to switch.

To be specific, the first TCI state pool is used for serving cell. N TCI state pools are used for candidate cell. Wherein, the second TCI state pool is used for candidate cell #1, the third TCI state pool is used for candidate cell #2, . . . , the N+1th TCI state pool is used for candidate cell #N.

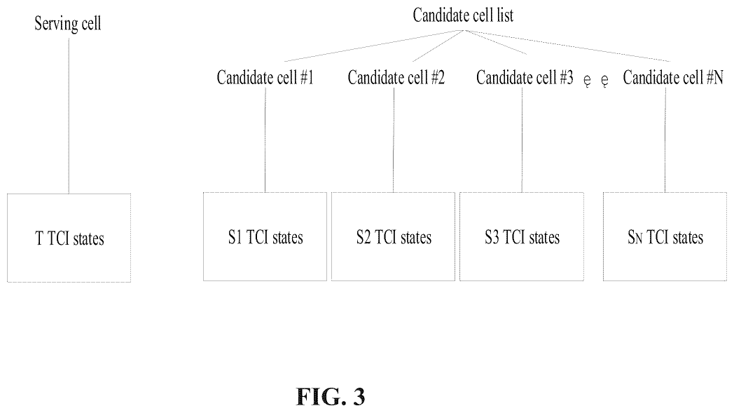

In some examples, the number of TCI state for the first TCI state pool is assumed as T. The number of TCI state for the second TCI state pool is assumed as S1, the number of TCI state for the third TCI state pool is assumed as S2 . . . , the number of TCI state for the N+1th TCI state pool is assumed as S_{N}, as shown in FIG. 3. T, S1, S2, . . . , or S_{N} is an integer larger than or equal to 1. The (maximum) value of T, S1, S2, . . . , or S_{N} can be a configurable value or fixed value or depends on UE capability. Optionally, the number of TCI state for different TCI state pools can be same or different.

Regarding the configuration of TCI state pool, one of the following methods can be considered:

For method-1, joint TCI state pool can be configured under serving cell, or outside serving cell and candidate cell configuration.

For method-2, the first TCI state pool can be configured under serving cell. The second TCI state pool can be configured under candidate cell or outside candidate cell configuration.

For method-3, the first TCI state pool can be configured under serving cell. N TCI state pools can be configured under corresponding candidate cell or outside candidate cell configuration.

### Embodiment 3

In this embodiment, we mainly introduce TCI state and/or TCI state pool activation or deactivation for candidate cell(s) or target cell.

Regarding TCI state activation or deactivation for candidate cell(s) or target cell, at least one of the following methods can be considered:

Method-1: Once TCI State(s) or TCI State Pool(s) are Configured or Indicated, then TCI State(s) or TCI State Pool(s) are Regarded to be Activated without Additional MAC CE Signaling or Activation Signaling.

In some examples, TCI state(s) or TCI state pool(s) are deactivated or updated by at least one of MAC CE signaling, RRC signaling, DCI signaling and a condition. Wherein, the condition can be one of measurement result, an event, history information, and so on. The event can be a case that UE switch from one cell to another cell, or measurement result is less than or equal to or greater than a threshold, or other similar rule.

Method-2: Activates or Deactivates W TCI State(s) from the Configured TCI State(s) and/or TCI State Pool(s).

In some examples, the signaling to activate or deactivate can be at least one of MAC CE and DCI signaling.

In some examples, the device to activate or deactivate can be at least one of UE, a network function or a base station.

In some examples, the device may activate or deactivate P TCI state pool(s). In some examples, TCI state pool can be for serving cell and/or candidate cell(s). This is to say, TCI state pool is associated with serving cell and/or candidate cell identification.

In some examples, the device may activate or deactivate Q TCI state(s) from at least one of the configured TCI state pool(s), the activated or deactivated TCI state pool(s).

In some examples, the device may activate or deactivate W TCI state(s). In some examples, TCI state can be from at least one of the activated or deactivated from the configured TCI state pool(s), the activated or deactivated TCI state pool(s), the TCI state(s) of the configured TCI state pool(s), the TCI state(s) of the activated or deactivated TCI state pool(s).

In some examples, TCI state is related to or identified as uplink UL or downlink DL.

In some examples, P, Q or W is an integer larger than or equal to 1. The (maximum) value of P, Q or W can be a configurable value or fixed value or depends on UE capability.

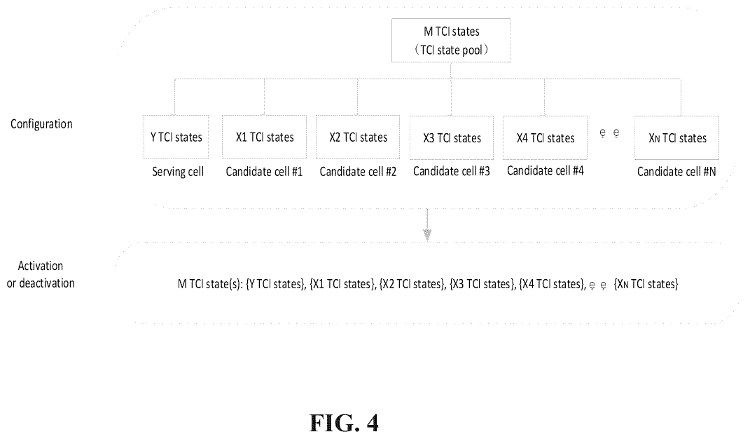

Note that any methods above mentioned can be used alone or in combination, as shown in FIG. 4 to FIG. 12.

### Embodiment 4

In the embodiment, we mainly introduce TCI state indication for candidate cell(s) or target cell. Optionally, TCI state indication can be for serving cell.

In some examples, TCI state for candidate cell(s) or target cell can be indicated together with cell switch command to indicate cell switch and/or some information.

In some examples, TCI state for candidate cell or target cell can be indicated to be independent of cell switch command.

In some examples, the signaling to indicate cell switch command can be MAC CE and/or DCI.

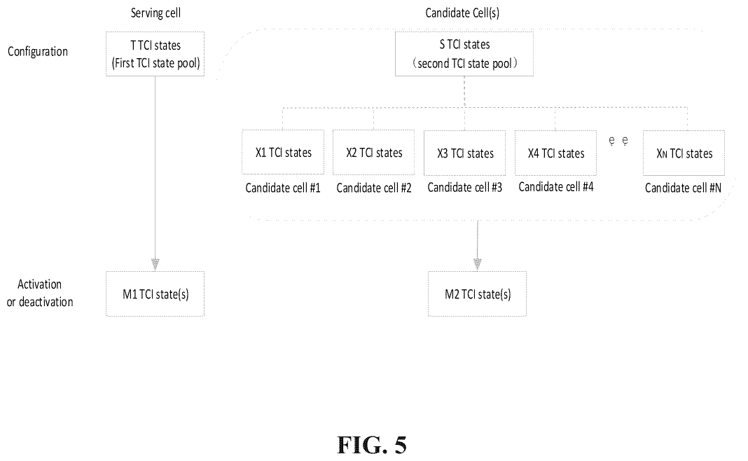

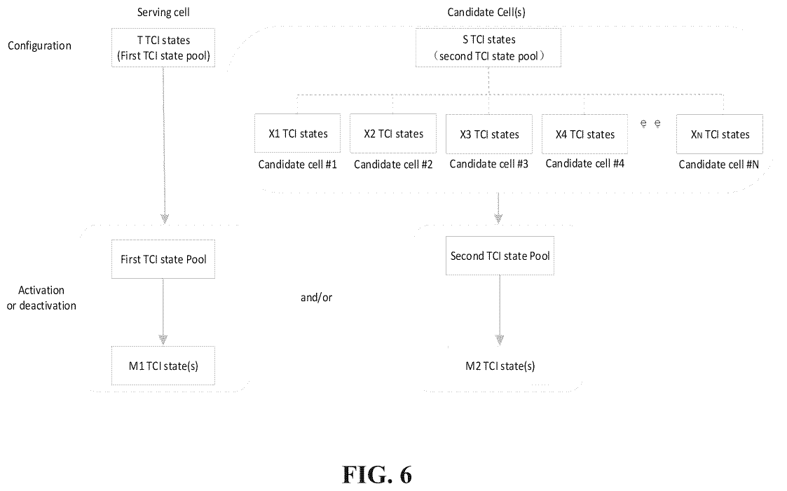

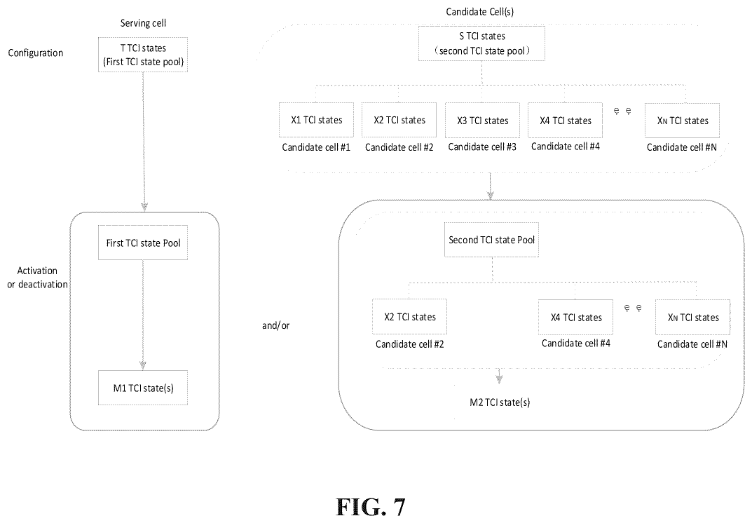

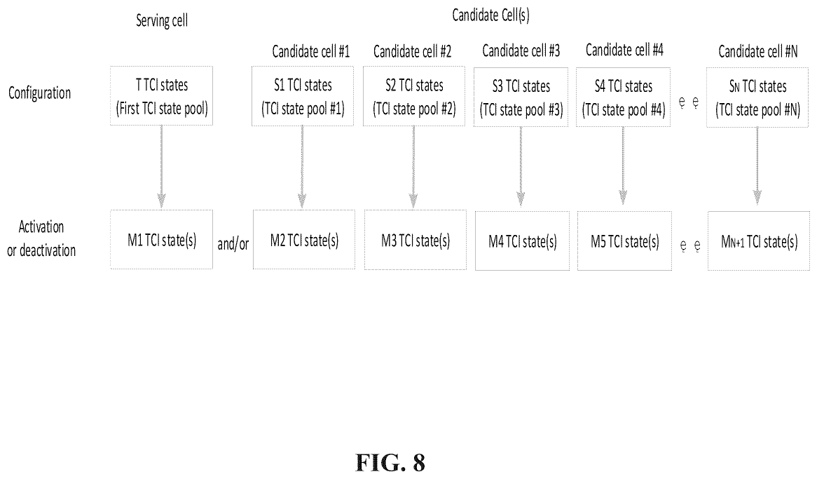

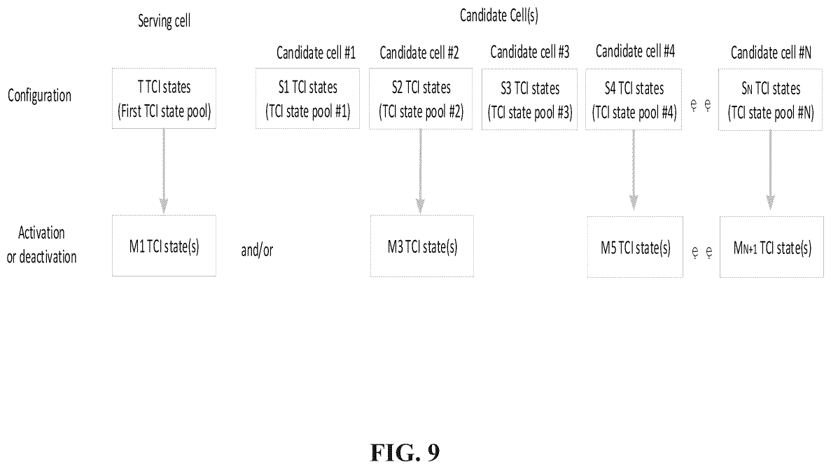

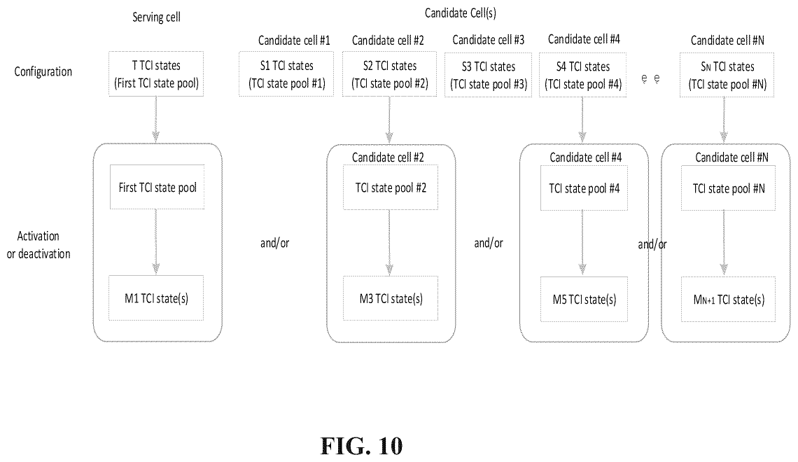

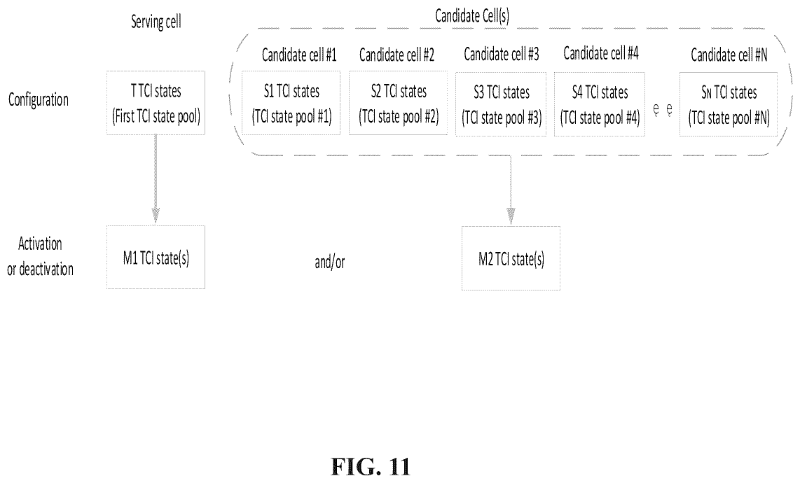

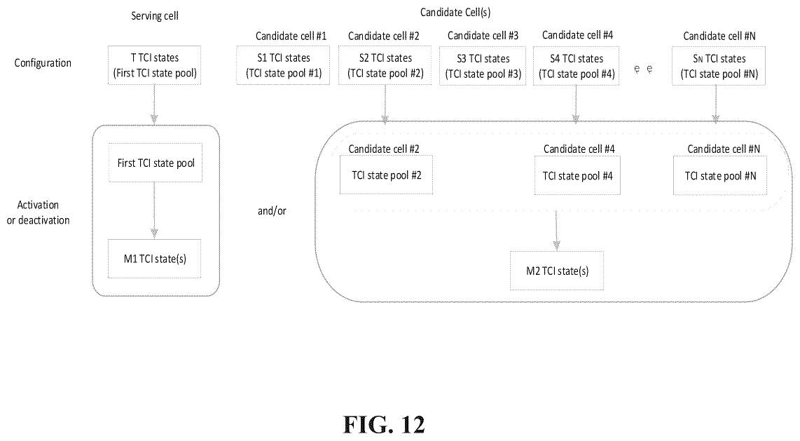

In some examples, the signaling to indicate TCI state can be MAC CE and/or DCI.
the indicated or updated TCI state can be based on at least one of the following:
   Case-1: the configured TCI state pool. As shown in FIG. 4.
   Case-2: the TCI state(s) of target cell in the configured TCI state pool. As shown in FIG. 4.
   Case-3: the activated M2 TCI state(s).
Case-3.1: M2 TCI state(s) are from one or multiple different candidate cell, as shown in FIG. 5.
Case-3.2: M2 TCI state(s) are from the activated TCI state pool, as shown in FIG. 6. Optionally, M2 TCI state may be from one or multiple different candidate cell.
Case-3.3: M2 TCI state(s) are from the activated TCI states(s) corresponding to one or multiple candidate cells, as shown in FIG. 7. Optionally, the activated TCI states(s) corresponding to one or multiple candidate cells is determined from TCI state pool, or the activated TCI state pool. Optionally, M2 TCI state may be from one or multiple different candidate cell.
Case-3.4: M2 TCI state(s) are from one or multiple TCI state pools. Wherein, each TCI state pool corresponds to a candidate cell. As shown in FIG. 11.
Case-3.5: M2 TCI state(s) are from one or multiple activated TCI state pools. Wherein, each activated TCI state pool corresponds to a candidate cell, as shown in FIG. 12.
Case-3.6: M2 TCI state(s) are from one or multiple activated TCI states corresponding to one or multiple different activated TCI state pools.
   Case-4: the activated Mᵢ TCI state(s). wherein, i is the index corresponding to the activated TCI state(s) and/or TCI state pool.
Case-4.1: Mᵢ TCI state(s) are from the configured Si−1 TCI state(s) or TCI state pool #i−1. Wherein, TCI state pool #i−1 corresponds to candidate cell #i−1. Mᵢ TCI state(s) corresponds to Si−1 TCI state(s) or TCI state pool #i−1, as shown in FIG. 8.
Case-4.2: Mᵢ TCI state(s) are from the corresponding activated Si−1 TCI state(s) or TCI state pool #i−1. Wherein, each Mᵢ TCI state(s) corresponds to corresponding Si−1 TCI state(s) or TCI state pool #i−1, as shown in FIG. 9.
Case-4.3: Mᵢ TCI state(s) are from the corresponding activated TCI state pool #i−1. Wherein, each Mᵢ TCI state(s) corresponds to corresponding TCI state pool #i−1, as shown in FIG. 10.

### Embodiment 5

In the embodiment, we mainly introduce application time of TCI state indication for candidate cell(s) or target cell and/or cell switch command.

In some examples, TCI state(s) for candidate cell(s) or target cell(s) can be indicated to be independent of cell switch command or together with cell switch command.

For the case that TCI state indication for candidate cell(s) or target cell together with cell switch command, at least one of the following method on application time of TCI state indication and/or cell switch command can be considered:

Scheme-1: the same effective time for beam indication and cell switch command.

For scheme-1, reference point to determine application time for beam indication and cell switch command can be determined by at least one of the following alternatives:
Alt-1: ending or starting time of receiving MAC CE signaling or DCI signaling;
Alt-2: ending or starting time of transmitting acknowledgement corresponding to MAC CE signaling if acknowledgement corresponding to MAC CE signaling is needed.

In various embodiments, MAC CE or DCI signaling is used to indicate cell switch command and/or beam indication.

For scheme-1, time gap to determine application time for beam indication and cell switch command can be determined by at least one of the following alternatives:
Alt-1: 3N, N is the number of sub-frame, or slot, or symbol, or frame.
Alt-2: new gap is defined considering at least one of beam switch time, cell (or cell group) switch time, timer to judge whether MAC CE to trigger cell switch is received by UE.

Scheme-2: independent effective time for beam indication and cell switch command

Different with scheme-1, different time gap can be defined for application of beam indication and application of cell switch command.

If the effective time of cell switch command is earlier than that of beam indication, then the following method can be considered:
Data is transmitted or received only when beam indication is taken effect.
Data is transmitted or received using the default beam.
Give up this data transmission or reception.

If the effective time of cell switch command is later than that of beam indication, then the following method can be considered:
Delay transmission or reception until cell switch command is taken effect
Transmit an information to avoid cell switch command is re-transmitted since timer expires.

For the case that TCI state indication for candidate cell(s) or target cell to be independent of cell switch command, at least one of the following method on application time of TCI state indication and/or cell switch command can be considered:

In principle, no limitation effective time for beam indication and cell switch command. But it would be better to take effect beam indication and cell switch command before timer to judge whether MAC CE to trigger cell switch is received by UE.

### Embodiment 6

In the embodiment, Tracking Reference Signal, TRS, can be seen as a type of CSI-RS. Wherein, TRS or CSI-RS can be periodic, or semi-persistent, or aperiodic; CSI-RS can be one of CSI-RS for CSI, CSI-RS beam management, CSI-RS for interference management, CSI-RS for mobility and other type of CSI-RS.

In some examples, TRS can be configured by at least one of the following methods: TRS is configured for candidate cell(s) or target cell; TRS is configured under serving cell or source cell; TRS is associated with candidate cell(s) or target cell.

In some examples, SS/PBCH block can be configured by at least one of the following methods: SS/PBCH block is configured for candidate cell(s) or target cell; SS/PBCH block is configured under serving cell or source cell; SS/PBCH block is associated with candidate cell(s) or target cell. Optionally, the same or similar method mentioned above can be applied for CSI-RS or SRS.

In some examples, at least one of the following relationship can be defined: TRS is associated with SS/PBCH block, or QCLed with SS/PBCH block; TRS is associated with CSI-RS, or QCLed with CSI-RS; CSI-RS can be associated with SS/PBCH block, or QCLed with SS/PBCH block; TRS or SS/PBCH block or CSI-RS can be associated with or QCL ed with SRS, or demodulation reference signal DMRS of PDSCH or PUSCH or PDCCH or PUCCH (referring to physical downlink shared channel, physical uplink shared channel, physical downlink control channel and physical uplink control channel). Wherein, type of QCL mentioned above can be at least one of QCL type A, QCL type B, QCL type C and QCL type D.

Note that one or more of the above mentioned method can be used alone or in combination.

The following solutions may be implemented by some preferred embodiments.

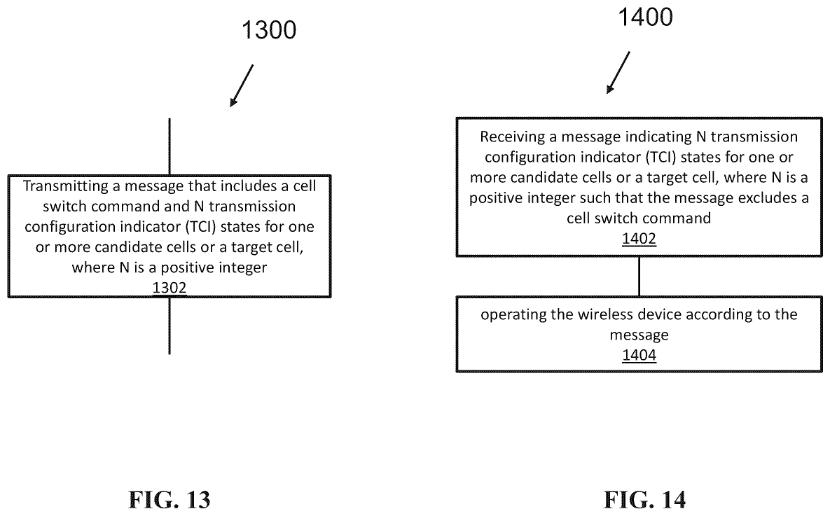

1. A method of wireless communication (e.g., method 1300 depicted in FIG. 13), comprising: transmitting (1302), by a network device, a message that includes a cell switch information and N transmission configuration indicator (TCI) states for one or more candidate cells or a target cell, where N is a positive integer.

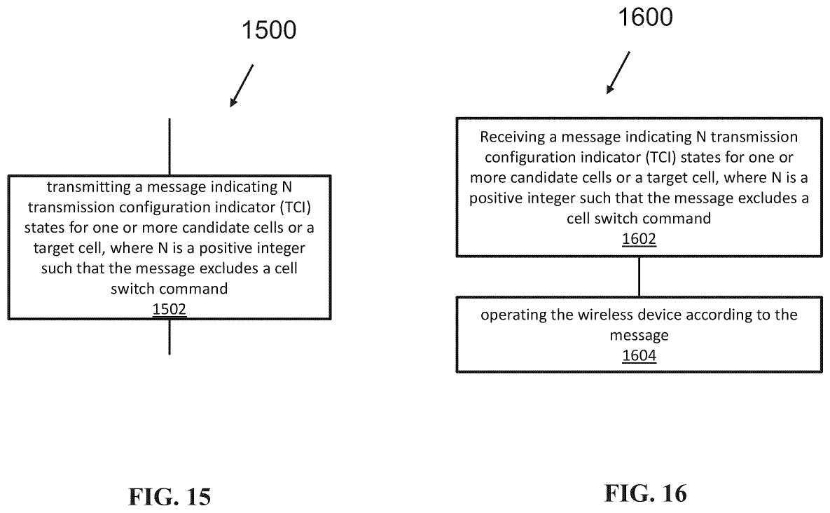

2. A method of wireless communication (e.g., method 1500 depicted in FIG. 15), comprising: transmitting (1502), by a network device, a message indicating N transmission configuration indicator (TCI) states for one or more candidate cells or a target cell, where N is a positive integer such that the message excludes a cell switch information.

3. A method of wireless communication (e.g., method 1400 depicted in FIG. 14), comprising: receiving (1402), by a wireless device from a network device, a message that includes a cell switch information and N transmission configuration indicator (TCI) states for one or more candidate cells or a target cell, where N is a positive integer; and operating (1404) the wireless device according to the message.

4. A method of wireless communication (e.g., method 1600 depicted in FIG. 16), comprising: receiving (1602), by a wireless device from a network device, a message indicating N transmission configuration indicator (TCI) states for one or more candidate cells or a target cell, where N is a positive integer such that the message excludes a cell switch information; and operating (1604) the wireless device according to the message.

In the present document, operating the wireless device may include transmitting or receiving a data signal or a control signal. For example the TCI states indicated to the UE may be used by the UE for a next transmission or reception of a signal.

Embodiments 1 to 5 provide additional details and examples of solutions 1 to 4.

5. The method of any of solutions 1-4, wherein a joint TCI state pool is configured for indicating the N TCI states for at least one of the one or more candidate cells, the target cell or a serving cell. Additional examples are disclosed in Embodiment 2, method 1.

6. The method of any of solutions 1-4, wherein a common TCI state pool is configured for indicating the N TCI states for at least one of the one or more candidate cells, the target cell and another TCI state pool is configured for indicating TCI states of a serving cell. Additional examples are disclosed in Embodiment 2, method 2.

7. The method of any of solutions 1-4, wherein separate TCI state pools are configured for at least one of the one or more candidate cells, the target cell or a serving cell. Additional examples are disclosed in Embodiment 2, method 3.

8. The method of any of solutions 1-7, wherein a particular TCI state is considered to be activated or deactivated or updated upon configuration or indication without communication of an activation or a deactivation or an update signaling. Additional examples are disclosed in Embodiment 3, method 1.

9. The method of any of solutions 1-7, wherein a particular TCI state is activated or deactivated or updated by an activation or deactivation or update signaling. Additional examples are disclosed in Embodiment 3, method 2.

10. The method of any of solutions 1-9, wherein a TCI state for at least one of a particular candidate cell, a target cell or a serving cell is activated or deactivated or updated by an activation or a deactivation or an update signaling. Additional examples are disclosed with reference to FIG. 7.

11. The method of any of solutions 1-10, wherein a TCI state pool for at least one of a particular candidate cell, a target cell or a serving cell is activated or deactivated or updated by an activation or a deactivation or an update signaling. Additional examples are disclosed with reference to FIG. 10.

12. The method of any of solutions 8-11, the activated or deactivated or updated particular TCI state for the candidate cell or the target cell is from at least one of the following: a common TCI state pool for at least one of the one or more candidate cells or the

target cell; a combination of TCI states of one or multiple different candidate cells of the combined TCI state pool of at least one of the one or more candidate cells or the target cell; a TCI state set corresponding to or in association with a candidate cell or the target cell; an activated or a deactivated or an updated TCI state set or a TCI state pool corresponding to or associated with a candidate cell or the target cell; an activated or a deactivated or an updated TCI state set or a TCI state pool from an activated or a deactivated or an updated candidate cell or the target cell. Additional examples are disclosed with reference to FIGS. 6 to 12.

13. The method of any of solutions 1-4, wherein at least one of an indicated TCI state or the cell switch information or cell switch command is applied or takes effect starting from a particular time.

14. The method of any of solutions 1-4, wherein an indicated TCI state and the cell switch information take effect at a same time.

15. The method of any of solutions 1-4, wherein an indicated TCI state and the cell switch information or cell switch command have independent effective times. It will be appreciated that this solution discloses two cases—one is TCI state and cell switch information to be transmitted in the same cell switch command, another is TCI state and cell switch command (note that cell switch command may not include TCI state) to be transmitted separately.

16. The method of any of solution 13-15, wherein the starting time is determined based on at least one of a reference time or a position or a time interval.

17. The method of solution 16, wherein the reference time or the position is at least one of the following: an ending time or a starting time of a signaling corresponding to transmitting or receiving at least one of TCI state or the cell switch command or the cell switch information; an ending time or a starting time of transmitting or receiving at least one of a TCI state or the cell switch command or cell the switch information; an ending time or a starting time of an acknowledgement to transmit or receive; an ending time or a starting time of transmission or reception of an acknowledgement corresponding to a signaling that is used for transmitting or receiving at least one of the TCI state or the cell switch command or the cell switch information; or an ending time or a starting time of transmission of an acknowledgement corresponding to transmitting or receiving at least one of a TCI state or the cell switch command or the cell switch information.

18. The method of solution 16, wherein the time interval is at least one of: M*N time units, where M, N are positive integers; a time gap.

19. The method of solution 18, wherein the unit of N or M is a sub-frame, a slot, a symbol, or a frame.

20. The method of solution 18, wherein the time gap is dependent on at least one of: a beam switch time, a cell or cell group switch time, a timer to judge whether a medium access control control element (MAC CE) to trigger a cell switch is received by a wireless device, a capability of the wireless device, a first symbol or a slot or a subframe or a frame after a fixed time interval, or a processing capability of time of the wireless device.

21. The method of solution 15, wherein for a case that the effective time of cell switch command or cell switch information is earlier than that of beam indication, at least one of the following is performed: data is transmitted or received only when beam indication has taken effect; data is transmitted or received using a default beam; or a current data transmission or reception is given up; or for a case that the effective time of cell switch command is later than that of beam indication, one of the following is performed: a transmission or reception is delayed until the cell switch command has taken effect; a transmit or receive an information to/from target cell to avoid cell switch command is re-transmitted.

The method of any of solutions 1-21, wherein the indicated TCI state is from at least one of the following: the activated or updated TCI state set, the configured TCI state pool, a cell switch command, or a signaling.

The method of any of solutions 1-22, wherein a signaling to transmit the message that includes the cell switch information and the N transmission configuration indicator (TCI) states for the one or more candidate cells or the target cell, or signaling to activate or deactivate or update or indicate relevant TCI state information comprises at least one of downlink control information (DCI) signaling, or medium access control control element (MAC CE) signaling.

The method of any of solutions 1-21, wherein the cell switch command or cell switch information includes at least one of: target cell or cell group identification, target candidate cell or cell group identification, a Timing Advance (TA), an SS/PBCH block configuration or index, an RSSI Measurement Timing Configuration (RMTC), a CSI-RS configuration, a CSI-RS resource set index, SRS resource index, SRS resource set index, a CSI-RS resource index, a CSI report configuration index, the gap of consecutive CSI-RS transmission occasion, the number of transmitting CSI-RS occasion, a TCI state index, a beam indication, a set of TCI state, a preamble index, a frequency information, a Bandwidth part (BWP) index, a measurement gap, times of cell switch command or information to be allowed to be transmitted, a ControlResourceSet (CORESET) information, a search space information, an activated or updated one or multiple TCI states, enable or maintain activated or updated one or multiple TCI states. For example, in some embodiments, cell switch information or command can indicate a TCI state to be used to transmit or receive DL/UL data for target cell. Further, this information or command can also determine whether to need to enable or maintain activated or updated or other candidate TCI states for this target cell.

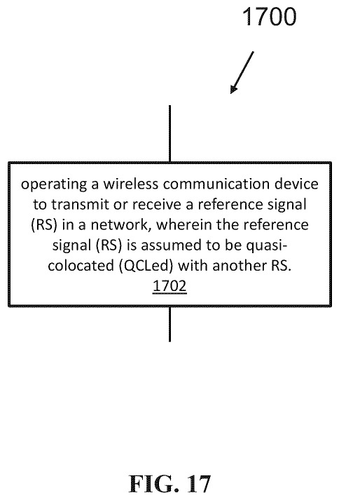

25. A method of wireless communication (e.g., method 1700 depicted in FIG. 17), comprising: operating (1702) a wireless communication device to transmit or receive a reference signal (RS) or channel or signal in a network, wherein the reference signal (RS) is assumed to be quasi-colocated (QCLed) with another RS. Additional examples and features are described with reference to Embodiment 6.

26. The method of solution 25, wherein the RS includes at least one of: a Tracking reference RS (TRS), a synchronization signal, physical broadcast channel (SS/PBCH) block, a channel state information reference signal (CSI-RS), a demodulation reference signal (DMRS) of physical downlink shared channel PDSCH, a DMRS of physical downlink control channel PDCCH, Sounding reference signal (SRS), a DMRS of physical uplink shared channel PUSCH, a DMRS of physical uplink control channel PUCCH, or a Path loss reference signal (PL-RS).

27. The method of solution 26, wherein the TRS or the CSI-RS is of a type: periodic, semi-persistent or aperiodic.

28. The method of solution 25, wherein the RS is configured for a candidate cell or a target cell; the RS is configured for a serving cell or a source cell; the RS is configured under a candidate cell or a target cell; or the RS is associated with the candidate cell or the target cell.

29. The method of any of solutions 25-28, wherein the RS is a source RS of an indicated transmission configuration indicator (TCI) state.

30. The method of any of solutions 25-29, wherein the wireless communication device comprises user equipment (UE).

31. The method of any of solutions 25-29, wherein the wireless communication device comprises a base station.

32. A wireless communication apparatus comprising a processor configured to implement a method recited in any of solutions 1-31.

33. A computer readable medium having code stored thereupon, the code, upon execution by a processor, causing the processor to implement a method recited in any of solutions 1-31.

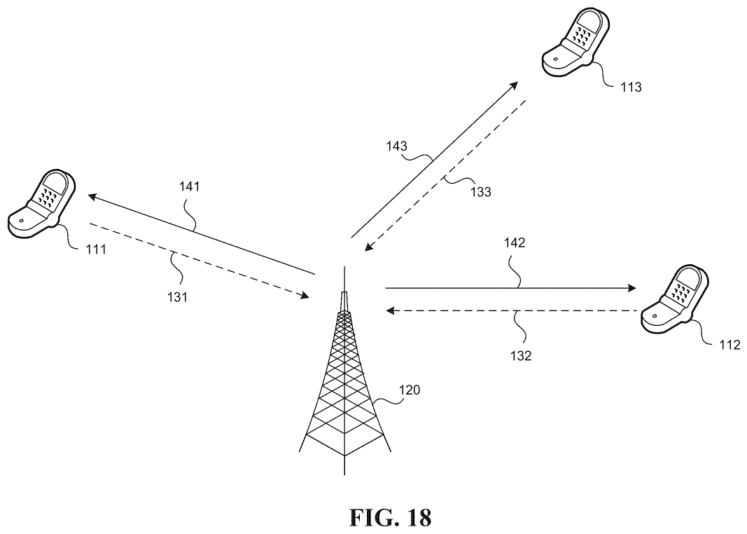

FIG. 18 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

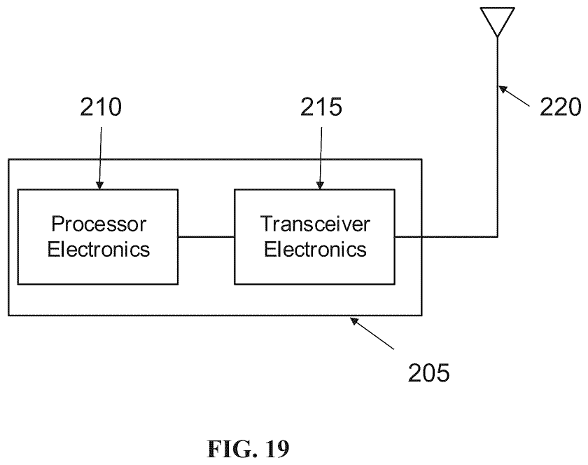

FIG. 19 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

It will be appreciated by one of skill in the art that the present document discloses a TCI state framework to indicate TCI state (see embodiment 1). It will further be appreciated that the present application discloses TCI state pool(s) for serving cell and/or candidate cell(s)(see embodiment 2), Activation or deactivation of TCI state pool and/or TCI state(s)(see embodiment 3), TCI state indication (see embodiment 4), Application time of TCI state indication and/or cell switch command (see embodiment 5), and QCL assumption (embodiment 6)

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

From the foregoing, it will be appreciated that specific embodiments of the invention have been described herein for purposes of illustration, but that various modifications may be made without deviating from the scope of the invention. Accordingly, the invention is not limited except as by the appended claims.

Only a few implementations and examples are described, and other implementations, enhancements, and variations can be made based on what is described and illustrated in this document.

1-33. (canceled)

34. A method of wireless communication, comprising:
receiving, by a wireless device from a network device, a medium access control (MAC) control element (CE) signaling of a cell switch command that indicates one or more transmission configuration indicator (TCI) states for one or more candidate cells or a target cell; and
operating the wireless device according to the MAC CE signaling.

35. The method of claim 34, wherein one or more indicated TCI states are from a TCI state pool, and wherein the TCI state pool is configured by a radio resource control (RRC) signaling.

36. The method of claim 34, wherein one or more indicated TCI states are from a set of activated or updated TCI states.

37. The method of claim 36, wherein another MAC CE signaling activates or updates a set of TCI states from a TCI state pool.

38. The method of claim 37, wherein:
a joint TCI state pool is configured for indicating the one or more TCI states for at least one of the one or more candidate cells, the target cell, or a serving cell;
a common TCI state pool is configured for indicating the one or more TCI states for at least one of the one or more candidate cells and the target cell, and wherein another TCI state pool is configured for indicating TCI states of the serving cell; or
separate TCI state pools are configured for at least one of the one or more candidate cells, the target cell, or the serving cell.

39. The method of any of claim 34, wherein:
at least one of an indicated TCI state, a cell switch information, or the cell switch command is applied or takes effect starting from a particular time, or
the indicated TCI state and the cell switch information take effect at a same time, or
the indicated TCI state and the cell switch information or the cell switch command have independent effective times, and
wherein a starting time is determined based on at least one of a reference time, a position, or a time interval.

40. The method of claim 39, wherein the reference time or the position is at least one of:
an ending time or a starting time of a signaling corresponding to transmitting or receiving at least one of TC state or the cell switch command or the cell switch information;
an ending time or a starting time of transmitting or receiving at least one of a TCI state or the cell switch command or the cell switch information;
an ending time or a starting time of an acknowledgement to transmit or receive;
an ending time or a starting time of transmission or reception of an acknowledgement corresponding to a signaling that is used for transmitting or receiving at least one of the TCI state or the cell switch command or the cell switch information; or
an ending time or a starting time of transmission of an acknowledgement corresponding to transmitting or receiving at least one of a TCI state or the cell switch command or the cell switch information.

41. The method of claim 39, wherein the time interval is at least one of:
M×N time units, wherein M and N are positive integers; or
a time gap.

42. The method of claim 34, wherein the cell switch command or a cell switch information includes at least one of: the target cell or a cell group identification, a target candidate cell or the cell group identification, a Timing Advance (TA), an SS/PBCH block configuration or index, an RSSI Measurement Timing Configuration (RMTC), a CSI-RS configuration, a CSI-RS resource set index, an SRS resource index, an SRS resource set index, a CSI-RS resource index, a CSI report configuration index, a gap of consecutive CSI-RS transmission occasion, a number of transmitting CSI-RS occasion, a TCI state index, a beam indication, a set of TC state, a preamble index, a frequency information, a Bandwidth part (BWP) index, a measurement gap, times of cell switch command or information to be allowed to be transmitted, a ControlResourceSet (CORESET) information, a search space information, an activated or updated one or multiple TCI states, enable or maintain activated or updated one or multiple TCI states.

43. The method of claim 34, wherein a tracking reference signal (TRS), a synchronization signal block (SSB), or a channel state information-reference signal (CSI-RS) in a TCI state is quasi co-located with a demodulation reference signal (DMRS) of a physical downlink shared channel (PDSCH) or a physical downlink control channel (PDCCH), and wherein being quasi co-located comprises quasi-location (QCL) type A, QCL type B, QCL type C, or QCL type D.

44. A method of wireless communication, comprising:
receiving, by a wireless device from a network device, a medium access control (MAC) control element (CE) signaling of a cell switch command that indicates one or more transmission configuration indicator (TCI) states for one or more candidate cells or a target cell; and
operating the wireless device according to the MAC CE signaling.

45. The method of claim 44, wherein one or more indicated TCI states are from a TCI state pool, and wherein the TCI state pool is configured by a radio resource control (RRC) signaling.

46. The method of claim 44, wherein one or more indicated TCI states are from a set of activated or updated TCI states, and wherein another MAC CE signaling activates or updates a set of TC states from a TCI state pool.

47. The method of claim 46, wherein:
a joint TCI state pool is configured for indicating the one or more TCI states for at least one of the one or more candidate cells, the target cell, or a serving cell;
a common TCI state pool is configured for indicating the one or more TCI states for at least one of the one or more candidate cells and the target cell, and wherein another TCI state pool is configured for indicating TCI states of the serving cell; or
separate TCI state pools are configured for at least one of the one or more candidate cells, the target cell, or the serving cell.

48. The method of any of claim 44, wherein:
at least one of an indicated TCI state, a cell switch information, or the cell switch command is applied or takes effect starting from a particular time, or
the indicated TCI state and the cell switch information take effect at a same time, or
the indicated TCI state and the cell switch information or the cell switch command have independent effective times, and
wherein a starting time is determined based on at least one of a reference time, a position, or a time interval.

49. The method of claim 48,
wherein the reference time or the position is at least one of:
an ending time or a starting time of a signaling corresponding to transmitting or receiving at least one of TC state or the cell switch command or the cell switch information;
an ending time or a starting time of transmitting or receiving at least one of a TCI state or the cell switch command or the cell switch information;
an ending time or a starting time of an acknowledgement to transmit or receive;
an ending time or a starting time of transmission or reception of an acknowledgement corresponding to a signaling that is used for transmitting or receiving at least one of the TCI state or the cell switch command or the cell switch information; or
an ending time or a starting time of transmission of an acknowledgement corresponding to transmitting or receiving at least one of a TCI state or the cell switch command or the cell switch information, and
wherein the time interval is at least one of:
M×N time units, wherein M and N are positive integers; or
a time gap.

50. The method of claim 44, wherein the cell switch command or a cell switch information includes at least one of: the target cell or a cell group identification, a target candidate cell or the cell group identification, a Timing Advance (TA), an SS/PBCH block configuration or index, an RSSI Measurement Timing Configuration (RMTC), a CSI-RS configuration, a CSI-RS resource set index, an SRS resource index, an SRS resource set index, a CSI-RS resource index, a CSI report configuration index, a gap of consecutive CSI-RS transmission occasion, a number of transmitting CSI-RS occasion, a TCI state index, a beam indication, a set of TCI state, a preamble index, a frequency information, a Bandwidth part (BWP) index, a measurement gap, times of cell switch command or information to be allowed to be transmitted, a ControlResourceSet (CORESET) information, a search space information, an activated or updated one or multiple TCI states, enable or maintain activated or updated one or multiple TCI states.

51. The method of claim 44, wherein a tracking reference signal (TRS), a synchronization signal block (SSB), or a channel state information-reference signal (CSI-RS) in a TCI state is quasi co-located with a demodulation reference signal (DMRS) of a physical downlink shared channel (PDSCH) or a physical downlink control channel (PDCCH), and wherein being quasi co-located comprises quasi-location (QCL) type A, QCL type B, QCL type C, or QCL type D.

52. An apparatus for wireless communication, comprising:
one or more processors configured to:
transmit, by a network device, a medium access control (MAC) control element (CE) signaling of a cell switch command that indicates one or more transmission configuration indicator (TCI) states for one or more candidate cells or a target cell.

53. An apparatus for wireless communication, comprising:
one or more processor configured to:
receive, by a wireless device from a network device, a medium access control (MAC) control element (CE) signaling of a cell switch command that indicates one or more transmission configuration indicator (TCI) states for one or more candidate cells or a target cell; and
operate the wireless device according to the MAC CE signaling.
